(19) United States
(12) Patent Application Publication
(10) Pub. No.: US 2011/0187467 A1
(43) Pub. Date: Aug. 4, 2011

(54) ATOMIC OSCILLATOR

(75) Inventor: Koji CHINDO, Kawasaki (JP)

(73) Assignee: SEIKO EPSON CORPORATION, Tokyo (JP)

(21) Appl. No.: 13/008,059

(22) Filed: Jan. 18, 2011

(30) Foreign Application Priority Data
Feb. 2, 2010 (JP) 2010-020946

(51) Int. Cl. H01S 1/06

(52) U.S. Cl. 331/94.1

(57) ABSTRACT

An atomic oscillator using an electromagnetically induced transparency phenomenon caused by irradiating a resonant light pair to an alkali metal atom, includes: a gaseous alkali metal atom; a light source that generates a plurality of lights having coherency and including a first light and a second light different from each other in frequency, and irradiates them to the alkali metal atom; a light detection part that receives a plurality of lights passing through the alkali metal atom and generates a detection signal including a beat signal of a specified frequency obtained by interference of the plurality of lights; and a frequency control part that performs frequency control of at least one of the first light and the second light based on the beat signal of the specified frequency included in the detection signal, and causes the first light and the second light to become a resonant light pair by which the electromagnetically induced transparency phenomenon is caused in the alkali metal atom.

### BACKGROUND

1. Technical Field

The present invention relate to an atomic oscillator.

2. Related Art

An atomic oscillator of an EIT (Electromagnetically Induced Transparency) system (also called a CPT (Coherent Population Trapping) system) is an oscillator using a phenomenon in which when two kinds of resonant lights having coherency and having specific wavelengths (frequencies) different from each other are simultaneously irradiated to an alkali metal atom, the absorption of the resonant lights is stopped.

It is known that the interaction mechanism between the alkali metal atom and the two resonant lights can be explained in a Λ-type three-level system model as shown in FIG. 17A. The alkali metal atom has two ground levels, and when resonant light 1 having a frequency corresponding to an energy difference between the ground level 1 and the excited level or resonant light 2 having a frequency corresponding to an energy difference between the ground level 2 and the excited level is individually irradiated to the alkali metal atom, light absorption occurs as is well known. However, when the resonant light 1 and the resonant light 2 are simultaneously irradiated to the alkali metal atom, a superimposed state of the two ground levels, that is, a quantum interference state occurs, the excitation to the excited level is stopped, and the transparency phenomenon (EIT phenomenon) occurs in which the resonant light 1 and the resonant light 2 pass through the alkali metal atom. Accordingly, when two kinds of lights having different frequencies are irradiated to an alkali metal atom, the light absorption behavior is abruptly changed according to whether the two kinds of lights become a resonant light pair and the alkali metal atom causes the EIT phenomenon. The frequency difference of the resonant light pair accurately coincides with a frequency corresponding to an energy difference ΔE₁₂ between the two ground levels (for example, 9.192631770 GHz for a cesium atom). Then, an oscillator with high accuracy can be realized by detecting the abrupt change of the light absorption behavior and by performing frequency control so that the two kinds of lights irradiated to the alkali metal atom become the resonant light pair, that is, the frequency difference between the two kinds of lights accurately coincides with the frequency corresponding to ΔE₁₂.

FIG. 18 is a schematic view of a general structure of a related art atomic oscillator of an EIT system. As shown in FIG. 18, in the related art atomic oscillator of the EIT system, a semiconductor laser is modulated by superimposing a modulation signal of a frequency fₘ on a drive current generated by a current drive circuit and for setting a frequency f₀ (=v/λ₀: v denotes the speed of light, λ₀ denotes the wavelength of light), so that a light of a frequency f₀+fₘ and a light of a frequency f₀−fₘ are generated. The two kinds of lights are simultaneously irradiated to a gas cell, and a light detector detects the intensities of the lights passing through the gas cell. The gas cell includes gaseous alkali metal atoms and a container for enclosing the atoms. When the two kinds of simultaneously irradiated lights become a resonant light pair, the alkali metal atom causes the EIT phenomenon, and the intensity of the light passing through the gas cell becomes large. In the atomic oscillator, detection is performed using a low frequency signal of several tens Hz to several hundreds Hz generated by a low frequency oscillator, and the oscillation frequency of a voltage controlled crystal oscillator (VCXO) is controlled so that the detection intensity becomes maximum, and the modulation signal is generated through a PLL (Phase Locked Loop). According to the structure as stated above, as shown in FIG. 17B, the control is performed so that the light of a frequency f₀+fₘ and the light of a frequency f₀−fₘ emitted by the semiconductor laser become the resonant light pair, that is, the frequency fₘ of the modulation signal coincides with the frequency of ½ of the frequency corresponding to ΔE₁₂. Accordingly, the oscillating operation of the voltage controlled crystal oscillator (VCXO) continues very stably, and the oscillation signal with very high frequency stability can be generated.

U.S. Pat. No. 6,320,472 is an example of related art.

However, in the related art atomic oscillator, since the voltage controlled crystal oscillator (VCXO), the detector circuit, the modulation circuit, the low frequency oscillator, the PLL and the like are required in order to generate the modulation signal of the frequency fₘ which accurately coincides with the frequency of ½ of the frequency corresponding to ΔE₁₂, there is a problem that the circuit inevitably becomes complicated, and it is difficult to achieve reduction in size and reduction in power consumption.

### SUMMARY

An advantage of some aspects of the invention is to provide an atomic oscillator in which reduction in size of a circuit portion and reduction in power consumption can be easily achieved.

According to an aspect of the invention, an atomic oscillator uses an electromagnetically induced transparency phenomenon caused by irradiating a resonant light pair to an alkali metal atom, and includes a gaseous alkali metal atom, a light source that generates plural lights having coherency and including a first light and a second light different from each other in frequency, and irradiates them to the alkali metal atom, a light detection part that receives plural lights passing through the alkali metal atom and generates a detection signal including a beat signal of a specified frequency obtained by interference of the plural lights, and a frequency control part that performs frequency control of at least one of the first light and the second light based on the beat signal of the specified frequency included in the detection signal, so that the first light and the second light become a resonant light pair to cause the electromagnetically induced transparency phenomenon to occur in the alkali metal atom.

In the related art atomic oscillator of the EIT system, since the output signal of the light detector is a DC (direct current) signal or a signal of a low frequency of several tens to several hundreds Hz, it is necessary that the voltage controlled crystal oscillator (VCXO) or the PLL is used to generate a high frequency signal of GHz band and the frequency control is performed to the light source. On the other hand, in the atomic oscillator of the aspect of the invention, the detection signal including the beat signal of the specified frequency obtained by the interference of the plural lights passing through the alkali metal atom, that is, the detection signal of the high frequency (GHz band) is generated. The frequency control part performs the frequency control based on the high frequency detection signal, so that the first light and the second light become the resonant light pair, and therefore, the PLL is not required.

Further, in the atomic oscillator of the aspect of the invention, the intensity of the light passing through the alkali metal atom is abruptly changed before and after the frequency difference between the first light and the second light coincides with the frequency corresponding to the energy difference between the two ground levels of the alkali metal atom. That is, a vary narrow band-limitation filter based on the transmission characteristic of the alkali metal atom is formed. Accordingly, when the frequency difference between the first light and the second light slightly shifts from the state where the frequency difference coincides with the frequency corresponding to the energy difference between the two ground levels of the alkali metal atom, feedback control is performed by the effect of the band-limitation filter so that the frequency difference coincides with the frequency corresponding to the energy difference between the two ground levels of the alkali metal atom. Thus, in the atomic oscillator of the aspect of the invention, even if the detector circuit and the voltage controlled crystal oscillator are not provided, a fine adjustment of the frequency difference between the first light and the second light is performed, and the stable oscillating operation can be continued.

Accordingly, according to the aspect of the invention, the atomic oscillator can be provided in which reduction in size of a circuit portion and reduction in power consumption are easily achieved as compared with the related art atomic oscillator.

The atomic oscillator of the aspect of the invention may be configured such that the frequency control part includes a filter to select the beat signal of the specified frequency from the detection signal and to allow it to pass through, and performs the frequency control based on the beat signal selected by the filter.

According to the atomic oscillator of the aspect of the invention, since the beat signal of the specified frequency required for the frequency control is selected by the filter, it is possible to prevent that the stable oscillating operation is hindered by the influence of other unnecessary beat signals.

The atomic oscillator of the aspect of the invention may be configured such that the frequency control part includes a signal amplification part to amplify the detection signal or the beat signal selected by the filter, and performs the frequency control based on the signal amplified by the signal amplification part.

By doing so, even when the level of the detection signal is not sufficient, the stability of the frequency control can be ensured.

The atomic oscillator of the aspect of the invention may be configured to include an optical filter to select two lights to generate the beat signal of the specified frequency from the plural lights passing through the alkali metal atom and to allow them to pass through.

Also by doing so, it is possible to prevent that the stable oscillating operation is hindered by the influence of unnecessary beat signals.

The atomic oscillator of the aspect of the invention may be configured such that the frequency control part includes a frequency conversion part to convert the beat signal of the specified frequency into a signal of a different frequency, and the frequency control part performs the frequency control based on the signal converted by the frequency conversion part.

The atomic oscillator of the aspect of the invention may be configured such that the frequency control part uses a beat signal of a frequency of ½ of a frequency difference between the first light and the second light as the beat signal of the specified frequency and performs the frequency control.

It is preferable that in the atomic oscillator, the frequency control part uses a beat signal of a frequency equal to a frequency difference between the first light and the second light as the beat signal of the specified frequency and performs the frequency control.

### BRIEF DESCRIPTION OF THE DRAWINGS

The invention will be described with reference to the accompanying drawings, wherein like numbers reference like elements.

FIG. 1 is a functional block diagram showing an example of an atomic oscillator of an embodiment.

FIG. 2 is a functional block diagram showing another example of the atomic oscillator of the embodiment.

FIG. 3 is a view showing a structure of an atomic oscillator of a first embodiment.

FIG. 4 is a view showing an example of the permeability characteristic of a gas cell.

FIG. 5 is a schematic view showing a frequency spectrum of outgoing light in the first embodiment.

FIGS. 6A to 6C are views for explaining the principle of frequency control.

FIG. 7 is a view showing a structure of a modified example of the first embodiment.

FIG. 8 is a view for explaining a frequency characteristic of an optical filter.

FIG. 9 is a view sowing a structure of an atomic oscillator of a second embodiment.

FIG. 10 is a view for explaining a frequency characteristic of an optical filter.

FIG. 11 is a view showing a structure of an atomic oscillator of a third embodiment.

FIG. 12 is a schematic view showing a frequency spectrum of outgoing light in the third embodiment.

FIG. 13 is a view for explaining a frequency characteristic of an optical filter.

FIG. 14 is a view showing a structure of an atomic oscillator of a fourth embodiment.

FIG. 15 is a schematic view of a graph showing Bessel functions.

FIGS. 16A to 16C are schematic views showing frequency spectra of outgoing lights in the fourth embodiment.

FIG. 17A is a view schematically showing energy levels of an alkali metal atom, and

FIG. 17B is a view showing a frequency spectrum of two resonant lights.

FIG. 18 is a schematic view showing a general structure of a related art atomic oscillator of an EIT system.

### DESCRIPTION OF EXEMPLARY EMBODIMENTS

Hereinafter, embodiments of the invention will be described in detail with reference to the drawings. Incidentally, the embodiments described below do not unduly limit the contents of the invention described in the appended claims. Besides, all structures described below are not necessarily inevitable components of the invention.

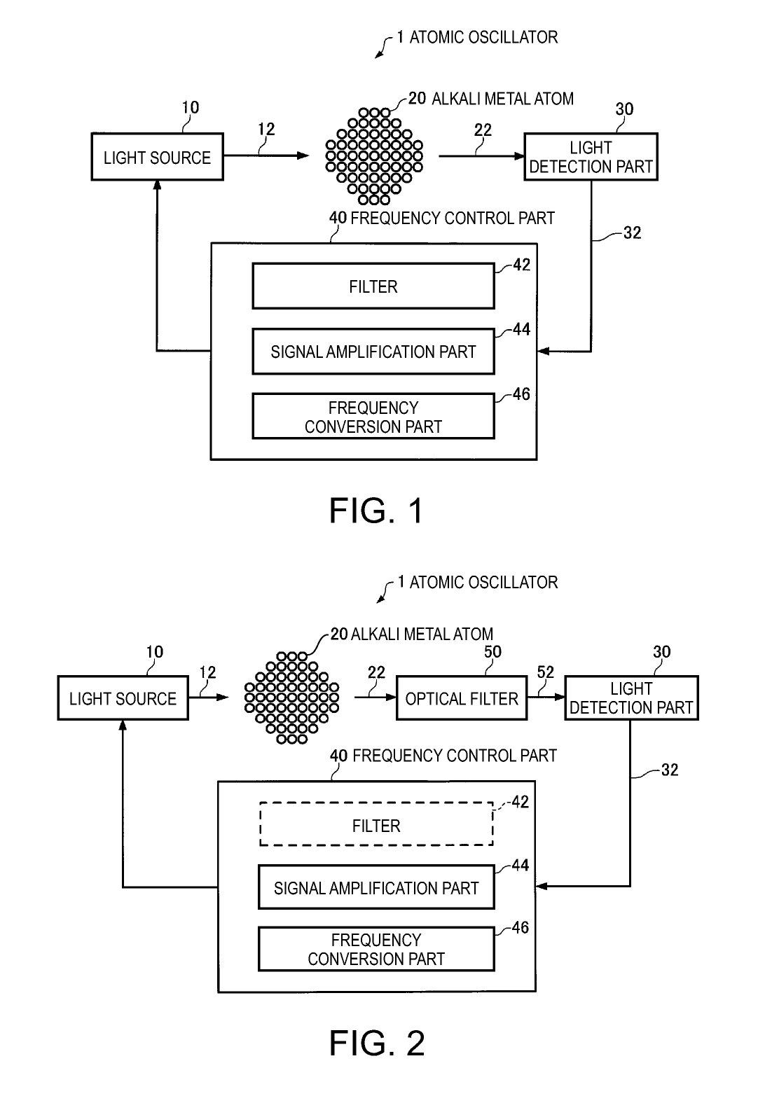

FIG. 1 is a functional block diagram of an atomic oscillator of an embodiment.

An atomic oscillator 1 of this embodiment includes a light source 10, an alkali metal atom 20, a light detection part 30 and a frequency control part 40.

The light source 10 generates plural lights 12 having coherency and including a first light and a second light different from each other in frequency, and irradiates them to the gaseous alkali metal atom 20 (natrium (Na) atom, rubidium (Rb) atom, cesium (Cs) atom, etc). For example, the laser light is a light having coherency.

The light detection part 30 receives plural lights (transmitted lights) 22 passing through the alkali metal atom 20, and generates a detection signal 32 including a beat signal of a specified frequency obtained by interference of the plural lights 22. The specified frequency may be a frequency equal to a frequency difference between the first light and the second light, or a frequency of ½ of the frequency difference between the first light and the second light.

Here, for example, a gas cell in which the gaseous alkali metal atom 20 is enclosed in a sealed container may be arranged between the light source 10 and the light detection part 30. Besides, the light source 10, the gaseous alkali metal atom 20 and the light detection part 30 are enclosed in a sealed container, and the light source 10 and the light detection part 30 may be arranged to be opposite to each other.

The frequency control part 40 performs frequency control of at least one of the first light and the second light based on the beat signal of the specified frequency included in the detection signal 32, so that the first light and the second light become a resonant light pair to cause the EIT phenomenon to occur in the alkali metal atom 20. Here, the resonant light pair is two kinds of lights having coherency and different in frequency, which cause the EIT phenomenon to occur in the alkali metal atom 20. Although it is preferable that the frequency difference therebetween accurately coincides with the frequency corresponding to the energy difference between the two ground levels of the alkali metal atom 20, the difference may include a minute error within a range where the alkali metal atom 20 causes the EIT phenomenon.

Besides, the frequency control part 40 may include at least one of a filter 42, a signal amplification part 44 and a frequency conversion part 46. The filter 42 selects the beat signal of the specified frequency from the detection signal 32 and allows it to pass through. The signal amplification part 44 amplifies the detection signal 32 or the beat signal selected by the filter 42. The frequency conversion part 46 converts the beat signal of the specified frequency included in the detection signal 32 of the light detection part 30 into a signal of a different frequency. The frequency control part 40 may perform the frequency control of at least one of the first light and the second light based on the beat signal selected by the filter 42, the signal amplified by the signal amplification part 44, or the signal converted by the frequency conversion part 46.

Further, as shown in FIG. 2, the atomic oscillator of this embodiment may include an optical filter 50. The optical filter 50 selects two lights 52 to generate a beat signal of a specified frequency from plural lights 22 passing through an alkali metal atom 20 and allows them to path through. Incidentally, the atomic oscillator 1 may include the optical filter 50 instead of the filter 42, or may include both the optical filter 50 and the filter 42.

Hereinafter, a more specific structure of the atomic oscillator of this embodiment will be described.

### (1) First Embodiment

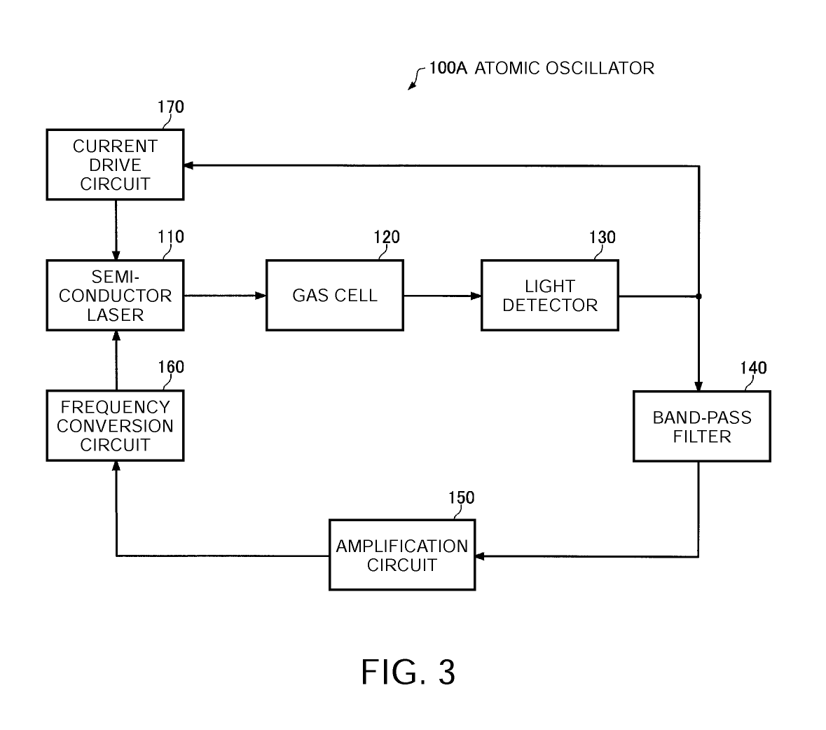

FIG. 3 is a view showing a structure of an atomic oscillator of a first embodiment.

As shown in FIG. 3, the atomic oscillator 100A of the first embodiment includes a semiconductor laser 110, a gas cell 120, a light detector 130, a band-pass filter 140, an amplification circuit 150, a frequency conversion circuit 160, and a current drive circuit 170.

The gas cell 120 is such that gaseous alkali metal atoms are enclosed in a container. When two kinds of lights having coherency and having a frequency difference equal to a frequency f₁₂ corresponding to an energy difference ΔE₁₂ between two ground levels of the alkali metal atom are simultaneously irradiated to the gas cell 120, the alkali metal atom causes the EIT phenomenon.

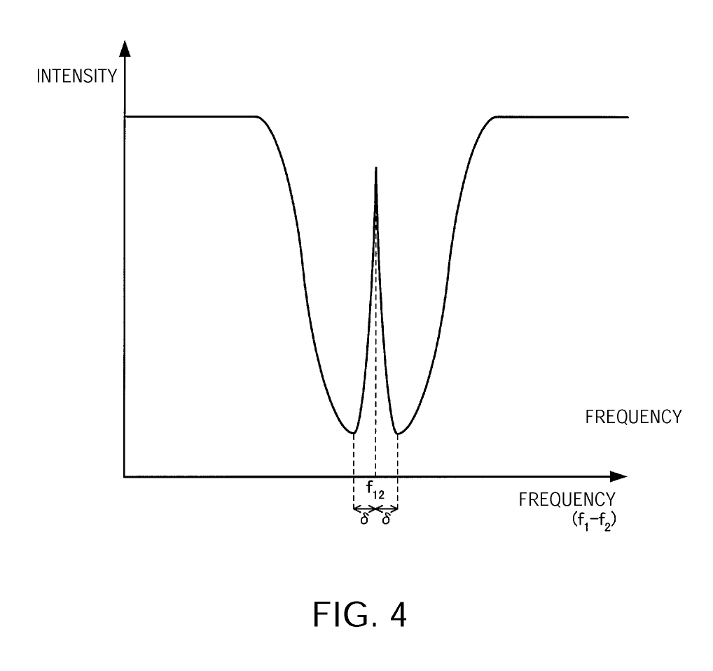

FIG. 4 is a schematic view showing a transmission characteristic when two kinds of laser lights having frequencies f₁ and f₂ are simultaneously irradiated to the gas cell 120 while f₁ is changed and f₂ is fixed. In FIG. 4, the horizontal axis indicates the frequency difference f₁−f₂ of the two kinds of laser lights and the vertical axis indicates the intensity of transmitted light.

As shown in FIG. 4, when the frequency difference f₁−f₂ between the two kinds of laser lights is within the range of f₁₂±δ (f₁₂ is the frequency corresponding to ΔE₁₂), the two kinds of laser lights become a resonant light pair, and the alkali metal atom causes the EIT phenomenon. Accordingly, when f₁−f₂ is within the range of f₁₂±δ, the intensity of the transmitted light is abruptly increased. When f₁−f₂ coincides with f₁₂, since the number of alkali metal atoms to stop light absorption by the EIT phenomenon becomes maximum, the intensity of the transmitted light becomes local maximum. For example, in a cesium atom, the ground state of a D2 line (wavelength is 852.1 nm) is split into two states having levels of F=3, 4 by ultra-fine structure, and a frequency corresponding to an energy difference between the ground level 1 of F=3 and the ground level 2 of F=4 is 9.192631770 GHz. Accordingly, when two kinds of laser lights having wavelengths of about 852.1 nm and a frequency difference of 9.192631770 GHz are simultaneously irradiated to the cesium atom, the two kinds of laser lights become a resonant light pair and the EIT phenomenon occurs, and the intensity of the transmitted light becomes local maximum.

The semiconductor laser 110 generates plural lights having different frequencies and irradiates them to the gas cell 120. Specifically, control is performed by a drive current outputted by the current drive circuit 170 so that the center wavelength λ₀ (center frequency is f₀) of the outgoing light of the semiconductor laser 110 coincides with the wavelength of a specified emission line (for example, the D2 line of the cesium atom) of the alkali metal atom. Besides, the semiconductor laser 110 is modulated by a modulation signal which is the output signal (frequency fₘ) of the frequency conversion circuit 160. That is, the output signal (modulation signal) of the frequency conversion circuit 160 is superimposed on the drive current of the current drive circuit 170, so that the semiconductor laser 110 generates the modulated light. The semiconductor laser 110 as stated above can be realized by, for example, a surface emitting laser such as an edge emitting laser or a vertical cavity surface emitting laser (VCSEL).

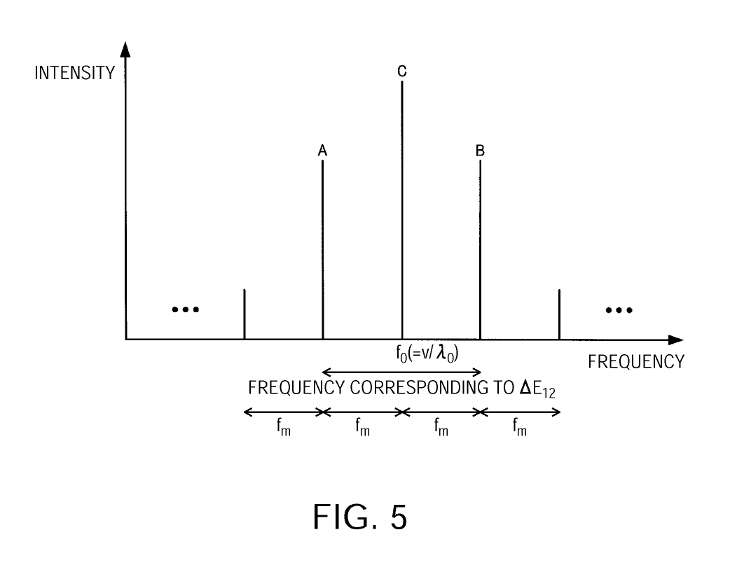

FIG. 5 is a schematic view showing a frequency spectrum of the outgoing light of the semiconductor laser in this embodiment. In FIG. 5, the horizontal axis indicates the frequency of light, and the vertical axis indicates the intensity of light.

As shown in FIG. 5, the semiconductor laser 110 generates a light C of a frequency f₀ and plural lights of frequencies f₀±n×fₘ (n is a positive integer) on both sides thereof. In this embodiment, control is performed so that a frequency difference between a light A (frequency is f₀−fₘ) as a primary side band and a light B (frequency is f₀+fₘ) coincides with a frequency corresponding to ΔE₁₂ (in other words, the frequency fₘ coincides with ½ of the frequency corresponding to ΔE₁₂) (the principle of the control will be described later). For example, when the alkali metal atom is the cesium atom, the control is performed so that the frequency difference (2×fₘ) between the light A and the light B becomes 9.192631770 GHz (frequency fₘ becomes 4.596315885 GHz).

The outgoing light of the semiconductor laser 110 is irradiated to the gas cell 120, and plural lights (transmitted lights) passing through the gas cell 120 overlap with each other and generate a beat (light beat). The whole intensity (light and darkness) of the transmitted lights is periodically changed according to the beat period.

The light detector 130 detects the periodic change of the intensity of the transmitted lights, and outputs a detection signal including a beat signal of a frequency equal to the frequency of the beat (beat frequency). Specifically, since the beat occurs between plural transmitted lights having different frequencies, the output signal (detection signal) of the light detector 130 includes plural beat signals having beat frequencies of N×fₘ (N is a positive integer). For example, when three transmitted lights corresponding to the lights A, B and C shown in FIG. 5 are made A′, B′ and C′, the beat frequency due to the transmitted light A′ and the transmitted light B′ is 2×fₘ (=frequency f₁₂ corresponding to ΔE₁₂), and the beat frequency due to the transmitted light A′ and the transmitted light C′ or due to the transmitted light B′ and the transmitted light C′ is fₘ (=½ of the frequency f₁₂ corresponding to ΔE₁₂). As the light detector 130 as stated above, for example, a photo-detector, which is used in the field of optical communication and can detect flicker at a frequency of GHz order, can be used.

The current drive circuit 170 adjusts the drive current so that the intensity of the output signal (detection signal) of the light detector 130 becomes local maximum. As a result, the influence of outer disturbance such as magnetic field change or temperature change is cancelled, and the center frequency f₀ (center wavelength λ₀) of the outgoing light of the semiconductor laser 110 can be stabilized.

The band-pass filter 140 selects and outputs the beat signal of the frequency of 2×fₘ (=f₁₂) from the output signal (detection signal) of the light detector 130. For example, when the alkali metal atom is the cesium atom, the band-pass filter 140 selects and outputs the beat signal of a frequency of about 9.1926 GHz. The band-pass filter 140 as stated above can be realized as the band-pass filter in which the beat frequency of 2×fₘ is included in a pass band, and other beat frequencies are not included in the pass band.

The amplification circuit 150 amplifies the amplitude of the output signal of the band-pass filter 140 at a specified gain. The gain of the amplification circuit 150 is set to a suitable value according to the detection sensitivity of the light detector 130 or the modulation sensitivity of the semiconductor laser 110, so that the stability of the feedback control can be ensured.

The frequency conversion circuit 160 converts the frequency of the output signal of the amplification circuit 150 into a half frequency thereof. For example, when the alkali metal atom is the cesium atom, since the frequency of the output signal of the amplification circuit 150 is about 9.192 GHz, the output signal is converted into a signal of a frequency of about 4.596 GHz by the frequency conversion circuit 160. The frequency conversion circuit 160 can be realized by a simple frequency divider.

The semiconductor laser 110 is modulated by the modulation signal which is the output signal of the frequency conversion circuit 160, and generates the lights A, B and C shown in FIG. 5.

Incidentally, the semiconductor laser 110 and the light detector 130 correspond to the light source 10 and the light detection part 30 of FIG. 1. Besides, a circuit including the band-pass filter 140, the amplification circuit 150, the frequency conversion circuit 160, and the current drive circuit 170 corresponds to the frequency control part 40 of FIG. 1. Besides, the band-pass filter 140, the amplification circuit 150, and the frequency conversion circuit 160 respectively correspond to the filter 42, the signal amplification part 44 and the frequency conversion part 46 of FIG. 1.

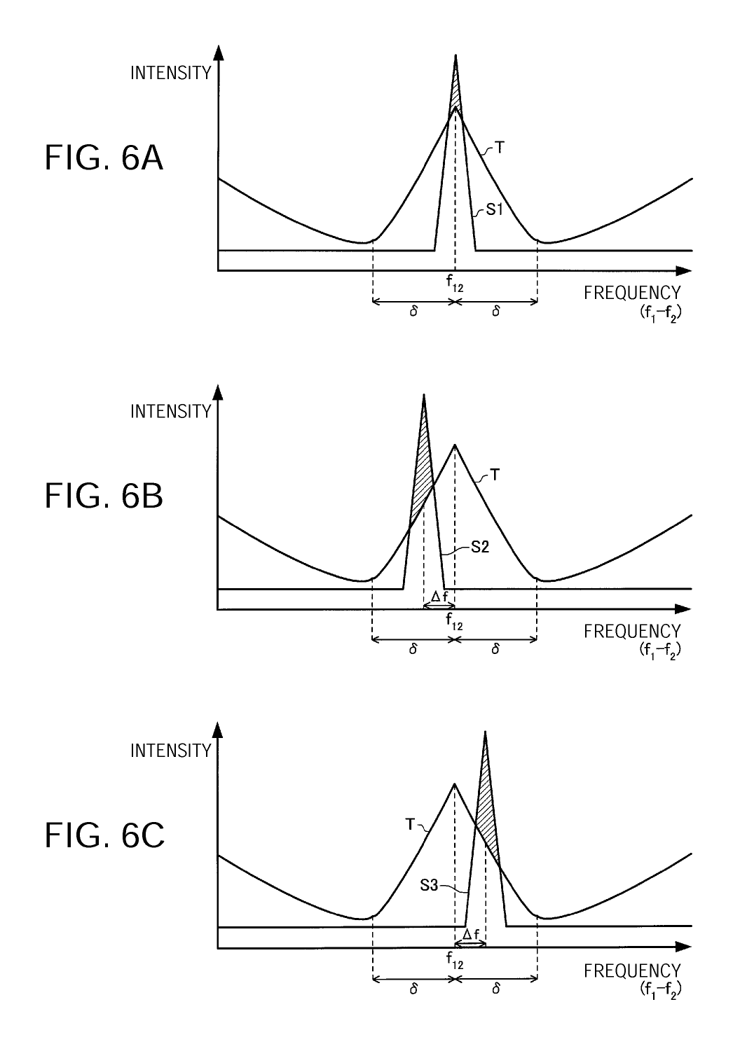

In the atomic oscillator 100A having the structure as described above, the principle based on which the control is performed so that the frequency difference 2×fₘ between the light A and the light B coincides with f₁₂ (in other words, the frequency fₘ coincides with ½ of the frequency f₁₂) will be described by use of FIG. 6A, FIG. 6B and FIG. 6C. Incidentally, the frequency of the light A is made f₂, and the frequency of the light B is made f₁.

In FIG. 6A, FIG. 6B and FIG. 6C, T represents an enlarged transmission characteristic in the vicinity of f₁₂±δ of FIG. 4, and S1, S2 and S3 represent frequency spectra of outgoing light. In FIG. 6A, FIG. 6B and FIG. 6C, the horizontal axis indicates the frequency difference f₁−f₂ between the light B and the light A, and the vertical axis indicates the intensity of the outgoing light or transmitted light.

First, when an average value of the frequency difference f₁−f₂ (=2×fₘ) between the light B and the light A coincides with f₁₂ (when an average value of fₘ is f₁₂×½), as shown in FIG. 6A, in the gas cell 120, an oblique line portion is absorbed with respect to the light A and the light B, and a portion other than the oblique line portion passes through. Accordingly, an average frequency difference between the transmitted light B′ and the transmitted light A′ also coincides with f₁₂, and an average value of the frequency of the beat signal due to the transmitted light A′ and the transmitted light B′ is f₁₂. At this time, since the average value of the frequency fₘ of the modulation signal is f₁₂/2 and is not changed, the feedback loop of the frequency control is stabilized in this condition.

In the state of FIG. 6A, it is assumed that the average frequency difference between the transmitted light B′ and the transmitted light A′ is changed to f₁₂−Δf by the influence of outer disturbance such as magnetic field change or temperature change. At this time, since the average value of the frequency of the beat signal due to the transmitted light A′ and the transmitted light B′ is also changed to f₁₂−Δf, the average value of the frequency fₘ of the modulation signal is changed to (f₁₂−Δf)/2. Then, the average value of the frequency difference f₁−f₂ (=2×fₘ) between the light B and the light A is changed to f₁₂−Δf, and as shown in FIG. 6B, in the gas cell 120, an oblique line portion is absorbed with respect to the light A and the light B, and a portion other than the oblique line portion passes through. Thus, the average frequency difference between the transmitted light B′ and the transmitted light A′ becomes larger than f₁₂−Δf. Accordingly, the average value of the frequency of the beat signal due to the transmitted light A′ and the transmitted light B′ increases, and the average value of the frequency fₘ of the modulation signal also increases. Thus, the average value of the frequency difference f₁−f₂ (=2×fₘ) between the light B and the light A also increases. By the feedback loop of the frequency control, an action is performed to return the state to the state of FIG. 6A, that is, the state in which the average frequency difference between the outgoing light B and the outgoing light A coincides with f₁₂ (average value of fₘ=f₁₂×½).

On the other hand, in the state of FIG. 6A, it is assumed that the average frequency difference between the transmitted light B′ and the transmitted light A′ is changed to f₁₂+Δf by the influence of outer disturbance such as magnetic field change or temperature change. At this time, since the average value of the frequency of beat signal due to the transmitted light A′ and the transmitted light B′ is also changed to f₂₂+Δf, the average value of the frequency fₘ of the modulation signal is changed to (f₁₂+Δf)/2. Then, the average value of the frequency difference f₁−f₂ (=2×fₘ) between the light B and the light A is changed to f₂₂+Δf, and as shown in FIG. 6C, in the gas cell 120, an oblique line portion is absorbed with respective to the light A and the light B, and a portion other than the oblique line portion passes through. Thus, the average frequency difference between the transmitted light B′ and the transmitted light A′ becomes lower than f₁₂+Δf. Accordingly, the average value of the frequency of the beat signal due to the transmitted light A′ and the transmitted light B′ decreases, and the average value of the frequency fₘ of the modulation signal also decreases. Thus, the average value of the frequency difference f₁−f₂ (=2×fₘ) between the light B and the light A also decreases. By the feedback loop of the frequency control, an action is performed to return the state to the state of FIG. 6A, that is, the state where the average frequency difference between the light B and the light A coincides with f₁₂ (average value of fₘ=f₁₂/2).

Incidentally, the output signal (detection signal) of the light detector includes beat signals other than the beat signal (beat signal of the frequency of 2×fₘ) due to the transmitted light A′ and the transmitted light B′. Then, in this embodiment, band limiting is performed by the band-pass filter 140 so that the stable feedback control by the beat signal of the frequency of 2×fₘ is performed.

As described above, in the atomic oscillator of the first embodiment, by using the transmission characteristic of the gas cell 120, the feedback control is performed so that the frequency difference between the light B and the light A coincides with the frequency corresponding to ΔE₁₂, that is, the light A and the light B become a resonant light pair. The feedback control can be realized by the circuit having the very simple structure as shown in FIG. 3 as compared with the related art structure. Accordingly, according to the first embodiment, the atomic oscillator in which reduction in size of a circuit portion and reduction in power consumption can be easily achieved can be realized.

### Modified Example

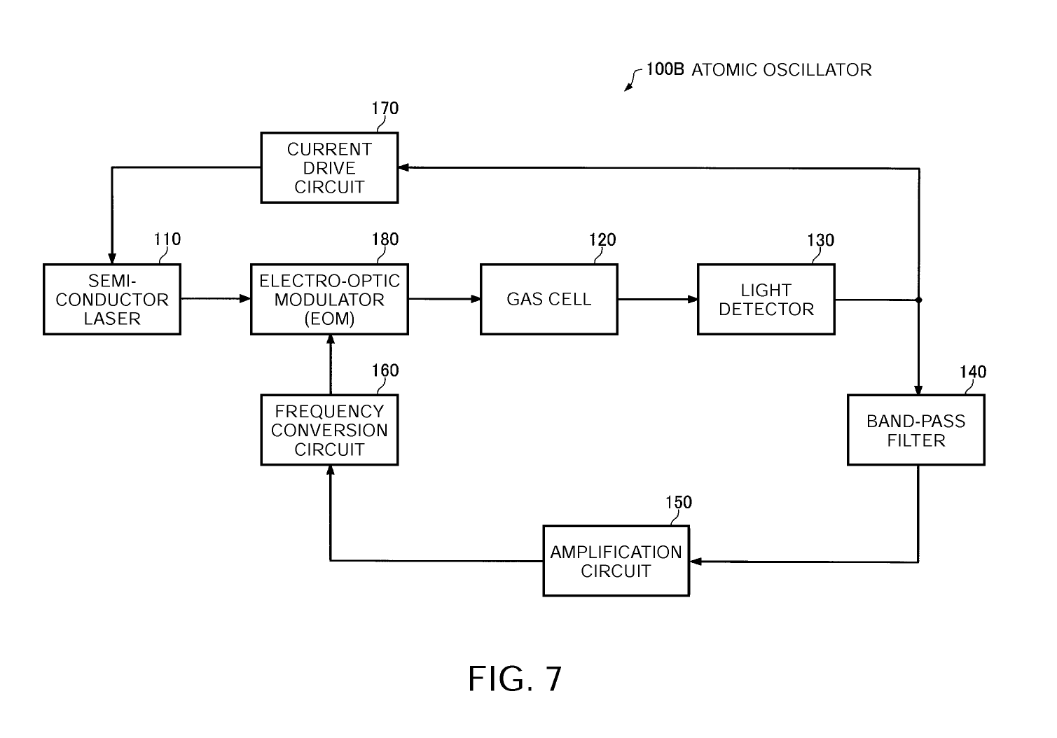

FIG. 7 is a view showing a structure of a modified example of the atomic oscillator of the first embodiment. As shown in FIG. 7, in an atomic oscillator 100B of the modified example, an electro-optic modulator (EOM) 180 is added to the atomic oscillator 100A shown in FIG. 3.

As shown in FIG. 7, in the atomic oscillator 100B, a semiconductor laser 110 is not modulated by an output signal (modulation signal) of a frequency conversion circuit 160 and generates a light of a single frequency f₀. The light of the frequency f₀ is incident on the electro-optic modulator 180, and is modulated by the output signal (modulation signal) of the frequency conversion circuit 160. As a result, the light having the same frequency spectrum as that of FIG. 5 can be generated.

Since the other structure of the atomic oscillator 100B shown in FIG. 7 is the same as that of the atomic oscillator 100A shown in FIG. 3, it is denoted by the same reference numeral and its description is omitted.

Incidentally, an acousto-optic modulator (AOM) may be used instead of the electro-optic modulator 180.

The structure of the semiconductor laser 110 and the electro-optic modulator 180 corresponds to the light source 10 of FIG. 1. The other correspondence relation is the same as that of the atomic oscillator 100A shown in FIG. 3.

Besides, as another modified example of the atomic oscillator 100A, a structure of an atomic oscillator can be made such that instead of the band-pass filter 140, an optical filter having a desired characteristic is provided between the gas cell 120 and the light detector 130.

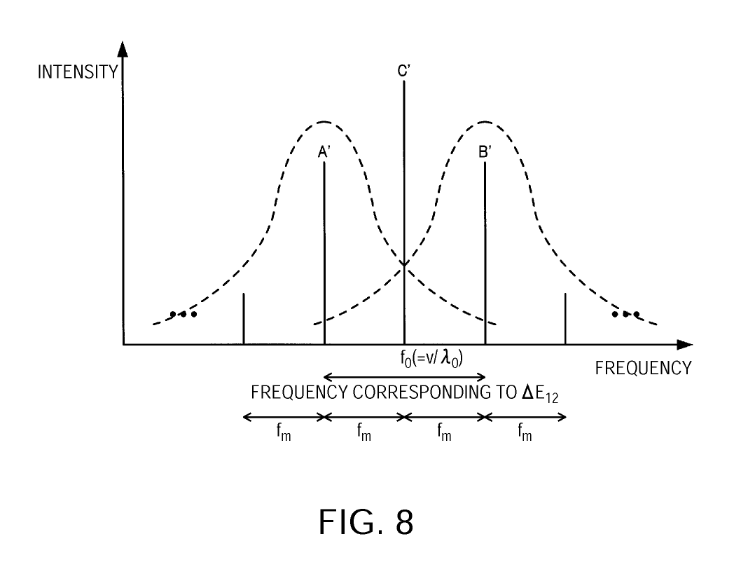

This optical filter has, for example, a frequency characteristic as indicated by a broken line in FIG. 8, and selectively allows the transmitted light A′ and the transmitted light B′ to pass through. By doing so, a beat other than the beat of the frequency of 2×fₘ generated by the transmitted light A′ and the transmitted light B′ becomes so small that it can be neglected, and it is possible to prevent that the stable oscillating operation is hindered by the influence of an unnecessary beat signal. Incidentally, this optical filter corresponds to the optical filter 50 of FIG. 2.

Also by the structures of the modified examples, the atomic oscillator having the same function and effect as those of the atomic oscillator 100A can be realized.

### (2) Second Embodiment

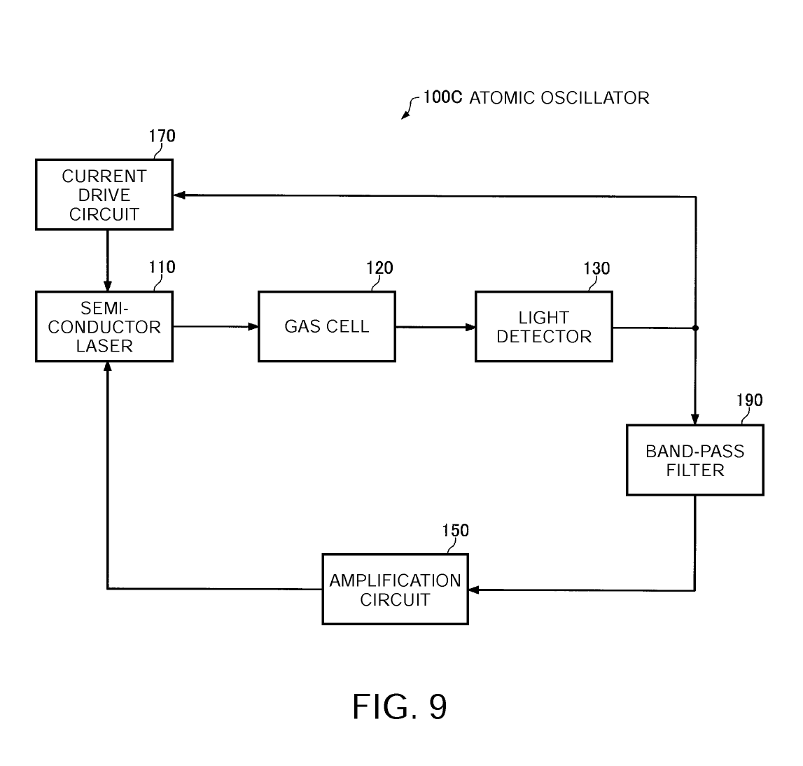

FIG. 9 is a view showing a structure of an atomic oscillator of a second embodiment. As shown in FIG. 9, in the atomic oscillator 100C of the second embodiment, as compared with the atomic oscillator 100A of the first embodiment shown in FIG. 3, the frequency conversion circuit 160 is not provided, and the band-pass filter 140 is replaced by a band-pass filter 190.

In this embodiment, the center frequency f₀ (center wavelength λ₀) of a semiconductor laser 110 is controlled by a drive current outputted by a current drive circuit 170, and the semiconductor laser 110 is modulated by an output signal (modulation signal of a frequency fₘ) of an amplification circuit 150. That is, the AC current of the output signal (modulation signal) of the amplification circuit 150 is superimposed on the drive current of the current drive circuit 170, and the semiconductor laser 110 is modulated.

Control is performed so that the center wavelength λ₀ of the semiconductor laser 110 coincides with the wavelength of a specified emission line (for example, the D2 line of the cesium atom) of the alkali metal atom, and the frequency fₘ of the output signal (modulation signal) of the amplification circuit 150 coincides with the frequency of ½ of the frequency f₁₂ corresponding to ΔE₁₂. For example, when the alkali metal atom is the cesium atom, the center wavelength λ₀ coincides with the wavelength (852.1 nm) of the D2 line, and the frequency fₘ coincides with 4.596315885 GHz (=9.192631770 GHz×½). Accordingly, also in this embodiment, the frequency spectrum of the outgoing light of the semiconductor laser 110 is the same as that of FIG. 5, and the light A and the light B become a resonant light pair.

The band-pass filter 190 selects and outputs the beat signal of the frequency of ½ of the frequency difference between the light A and the light B (resonant light pair), that is, the beat signal of the frequency fₘ from the output signal (detection signal) of a light detector 130. For example, when the alkali metal atom is the cesium atom, the band-pass filter 190 selects and outputs the beat signal of 4.596315885 GHz.

The band-pass filter 190 as described above can be realized as the band-pass filter in which the beat frequency of fₘ is included in a pass band, and other beat frequencies are not included in the pass band.

The amplification circuit 150 amplifies the amplitude of the output signal of the band-pass filter 190 and outputs it. The semiconductor laser 110 is modulated by the modulation signal which is the output signal of the amplification circuit 150, and generates the lights A, B and C shown in FIG. 5.

Since the other structure in the atomic oscillator 100C is the same as that of the atomic oscillator 100A shown in FIG. 3, it is denoted by the same reference numeral and its description is omitted.

Incidentally, the semiconductor laser 110 and the light detector 130 correspond to the light source 10 and the light detection part 30 of FIG. 1. Besides, a circuit including the band-pass filter 190, the amplification circuit 150 and the current drive circuit 170 correspond to the frequency control part 40 of FIG. 1. The band-pass filter 190 and the amplification circuit 150 correspond to the filer 42 and the signal amplification part 44 of FIG. 1.

Also in the atomic oscillator 100C having the structure as described above, based on the same principle as the atomic oscillator 100A, the feedback control is performed so that the frequency difference 2×fₘ between the light B and the light A coincides with the frequency corresponding to ΔE₁₂, that is, the light A and the light B become a resonant light pair. The feedback control can be realized by the circuit having the very simple structure as shown in FIG. 9 as compared with the related art structure. Accordingly, according to the second embodiment, the atomic oscillator in which reduction in size of a circuit portion and reduction in power consumption can be easily achieved can be realized.

### Modified Example

Also in the atomic oscillator 100C, instead of superimposing the modulation signal on the drive current of the semiconductor laser 110, as in the atomic oscillator 100B shown in FIG. 7, the outgoing light of the semiconductor laser 110 may be modulated by using an electro-optic modulator or an acousto-optic modulator.

Besides, as another modified example of the atomic oscillator 100C, a structure of an atomic oscillator can be made such that instead of the band-pass filter 190, an optical filter having a desired characteristic is provided between the gas cell 120 and the light detector 130.

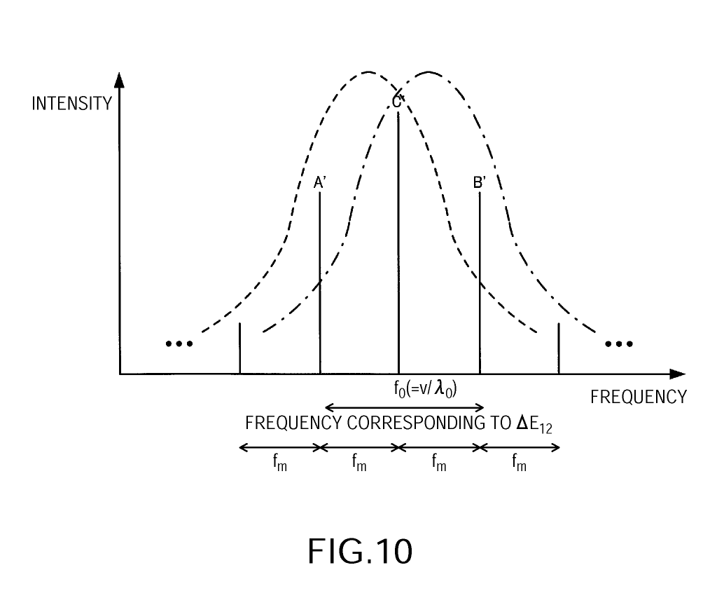

This optical filter has, for example, a frequency characteristic as indicated by a broken line or an alternate long and short dash line in FIG. 10, and selectively allows a transmitted light A′ and a transmitted light C′ or a transmitted light B′ and the transmitted light C′ to pass through. By doing so, a beat other than a beat of a frequency fₘ generated by the transmitted light A′ and the transmitted light C′ or by the transmitted light B′ and the transmitted light C′ becomes so small that it can be neglected, and it is possible to prevent that the stable oscillating operation is hindered by the influence of an unnecessary beat signal. Incidentally, this optical filter corresponds to the optical filter 50 of FIG. 2.

Also by the structures of the modified examples, the atomic oscillator having the same function and effect as those of the atomic oscillator 100C can be realized.

### (3) Third Embodiment

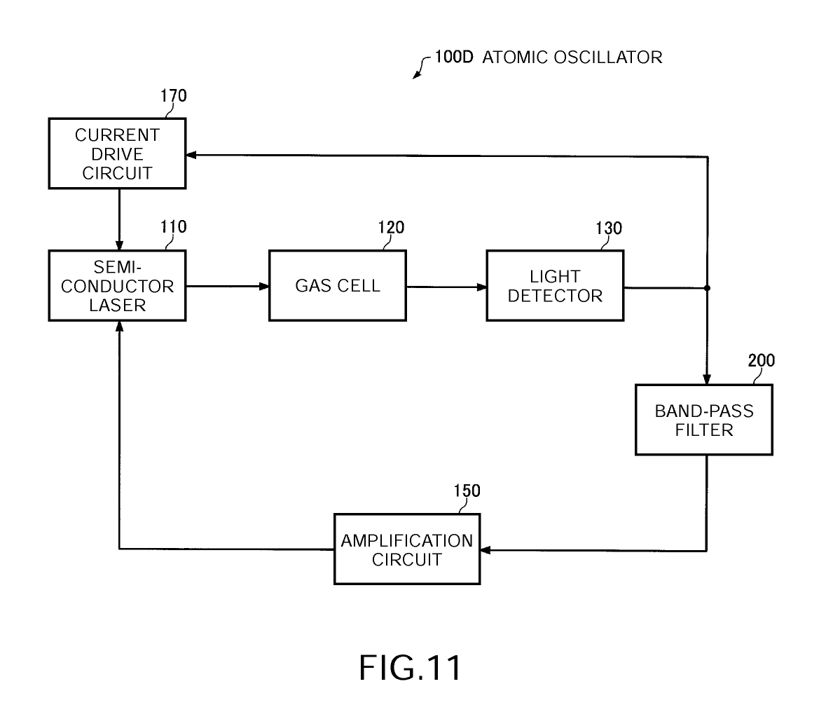

FIG. 11 is a view showing a structure of an atomic oscillator of a third embodiment. As shown in FIG. 11, in the atomic oscillator 100D of the third embodiment, as compared with the atomic oscillator 100A of the first embodiment shown in FIG. 3, the frequency conversion circuit 160 is not provided, and the band-pass filter 140 is replaced by a band-pass filter 200.

In this embodiment, the center frequency f₀ (center wavelength λ₀) of a semiconductor laser 110 is controlled by a drive current outputted by a current drive circuit 170, and the semiconductor laser 110 is modulated by an output signal (modulation signal of a frequency fₘ) of an amplification circuit 150. That is, the AC current of the output signal (modulation signal) of the amplification circuit 150 is superimposed on the drive current of the current drive circuit 170, so that the semiconductor laser 110 is modulated.

Control is performed so that the center wavelength λ₀ of the semiconductor laser 110 coincides with the wavelength of a specified emission line (for example, the D2 line of the cesium atom) of an alkali metal atom, and the frequency fₘ of the output signal (modulation signal) of the amplification circuit 150 coincides with the frequency corresponding to ΔE₁₂. For example, when the alkali metal atom is the cesium atom, the center wavelength λ₀ coincides with the wavelength (852.1 nm) of the D2 line, and the frequency fₘ coincides with 9.192631770 GHz.

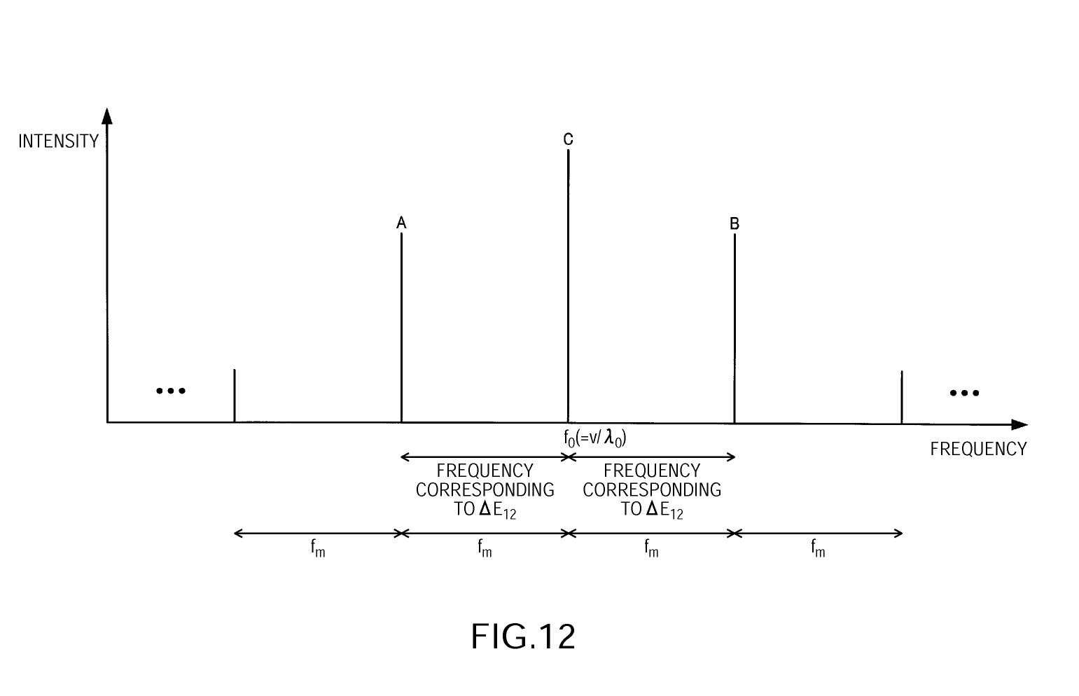

FIG. 12 is schematic view showing a frequency spectrum of outgoing light of the semiconductor laser in this embodiment. In FIG. 12, the horizontal axis indicates the frequency of light, and the vertical axis indicates the intensity of light.

As shown in FIG. 12, the semiconductor laser 110 generates a light C of a frequency f₀, and plural lights of frequencies of f₀±n×fₘ (n is a positive integer) on both sides thereof. Control is performed so that the frequency difference between the light C and the light A or the light B as the primary side band coincides with the frequency corresponding to ΔE₁₂ (in other words, the frequency fₘ coincides with the frequency corresponding to ΔE₁₂).

For example, when the alkali metal atom is the cesium atom, the control is performed so that the frequency difference (fₘ) between the light A and the light C and the frequency difference (fₘ) between the light B and the light C become 9.192631770 GHz.

As described above, in this embodiment, since the light A and the light C, and the light B and the light C become resonant light pairs and cause the EIT phenomenon, the transmittances of the light A, the light B and light C abruptly change in the vicinity where the frequency difference coincides with the frequency corresponding to ΔE₁₂.

Since beats are generated between plural transmitted lights having different in frequencies, the output signal (detection signal) of the light detector 130 includes plural signals having beat frequencies of N×fₘ (N is a positive integer). For example, when three transmitted lights corresponding to the lights A, B and C shown in FIG. 12 are A′, B′ and C′, the beat frequency due to the transmitted light A′ and the transmitted light B′ is 2×fₘ (=twice the frequency corresponding to ΔE₁₂), and the beat frequency due to the transmitted light A′ and the transmitted light C′ or due to the transmitted light B′ and the transmitted light C′ is fₘ (=frequency corresponding to ΔE₁₂).

The band-pass filter 200 selects and outputs the beat signal of the frequency equal to the frequency difference between the light A and the light C or between the light B and the light C, that is, the beat signal of the frequency fₘ from the output signal (detection signal) of the light detector 130. For example, when the alkali metal atom is the cesium atom, the band-pass filter 190 selects and outputs the beat signal of 9.192631770 GHz.

The band-pass filter 200 as stated above can be realized as the band-pass filter in which the beat frequency fₘ is included in a pass band, and other beat frequencies are not included in the pass band.

The amplification circuit 150 amplifies the amplitude of the output signal of the band-pass filter 200 and outputs it. The semiconductor laser 110 is modulated by the modulation signal which is the output signal of the amplification circuit 150, and generates the lights A, B and C shown in FIG. 12.

Since the other structure of the atomic oscillator 100D is the same as that of the atomic oscillator 100A shown in FIG. 3, it is denoted by the same reference numeral and its description is omitted.

Incidentally, the semiconductor laser 110 and the light detector 130 correspond to the light source 10 and the light detection part 30 of FIG. 1. Besides, a circuit including the band-pass filter 200, the amplification circuit 150, and the current drive circuit 170 corresponds to the frequency control part 40 of FIG. 1. Besides, the band-pass filter 200 and the amplification circuit 150 correspond to the filter 42 and the signal amplification part 44 of FIG. 1.

Also in the atomic oscillator 100D having the structure as described above, based on the same principle as the atomic oscillator 100A, the feedback control is performed so that the frequency difference between the light A and the light C and the frequency difference between the light B and the light C coincide with the frequency corresponding to ΔE₁₂, that is, the light A and the light C, and the light B and the light C become resonant light pairs. The feedback control can be realized by the circuit having the very simple structure as shown in FIG. 11 as compared with the related art structure. Accordingly, according to the third embodiment, the atomic oscillator in which reduction in size of a circuit portion and reduction in power consumption can be easily achieved can be realized.

### Modified Example

Also in the atomic oscillator 100D, as in the atomic oscillator 100B shown in FIG. 7, the outgoing light of the semiconductor laser 110 may be modulated by using an electro-optic modulator or an acousto-optic modulator instead of superimposing the modulation signal on the drive current to the semiconductor laser 110.

Besides, as another modified example of the atomic oscillator 100D, a structure of an atomic oscillator can be made such that instead of the band-pass filter 200, an optical filter having a desired characteristic is provided between the gas cell 120 and the light detector 130.

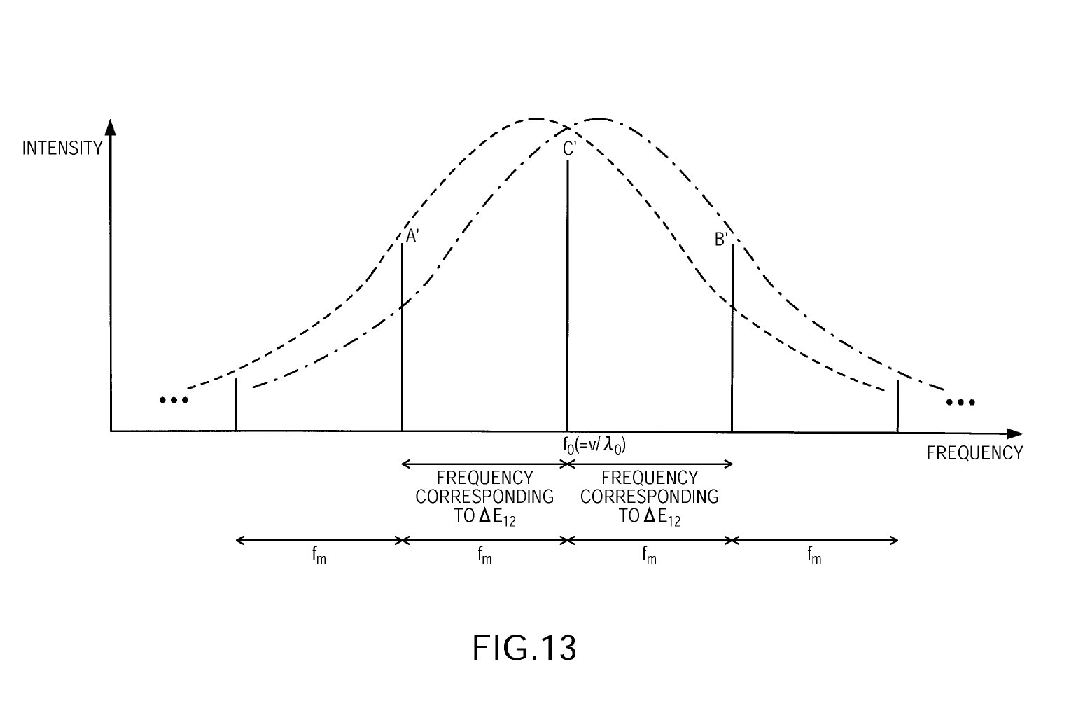

This optical filter has, for example, a frequency characteristic as indicated by a broken line or a long and short dash line in FIG. 13, and selectively allows the transmitted light A′ and the transmitted light C′ or the transmitted light B′ and the transmitted light C′ to pass through. By doing so, a beat other than the beat of the frequency fₘ generated by the transmitted light A′ and the transmitted light C′ or the transmitted light B′ and the transmitted light C′ becomes so small that it can be neglected, and it is possible to prevent that the stable oscillating operation is hindered by the influence of an unnecessary beat signal. Incidentally, this optical filter corresponds to the optical filter 50 of FIG. 2.

Also by the structures of the modified examples, the atomic oscillator having the same function and effect as those of the atomic oscillator 100D can be realized.

### (4) Fourth Embodiment

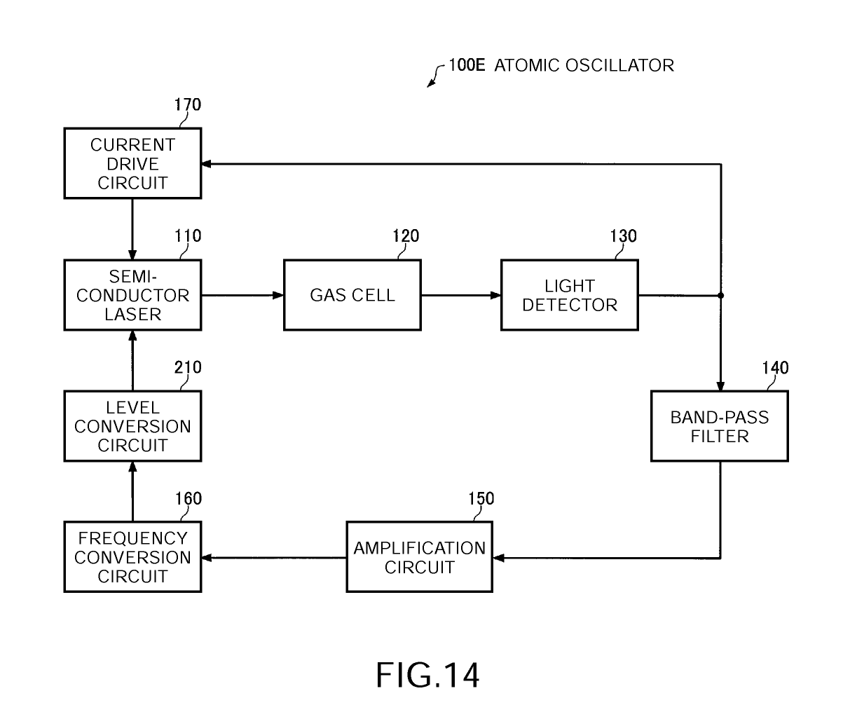

FIG. 14 is a view showing a structure of an atomic oscillator of a fourth embodiment. As shown in FIG. 14, in the atomic oscillator 100E of the fourth embodiment, as compared with the atomic oscillator 100A of the first embodiment, a level adjustment circuit 210 is added between a frequency conversion circuit 160 and a semiconductor laser 110.

The level adjustment circuit 210 adjusts the amplitude of an output signal of the frequency conversion circuit 160 to a specified magnitude and outputs it. The semiconductor laser 110 generates a light modulated by a modulation signal which is the output signal of the level adjustment circuit 210.

Since the other structure of the atomic oscillator 100E is the same as that of the atomic oscillator 100A shown in FIG. 3, it is denoted by the same reference numeral and its description is omitted.

Here, when the amplitude of the outgoing light (frequency f₀) when the semiconductor laser 110 is not modulated is A₀, the outgoing light frequency-modulated by the modulation signal (output signal of the level adjustment circuit 210) of the frequency fₘ is expressed by the following expression (1).

$${A}_{FM} = {A}_{0} [ \begin{matrix}{J}_{0} ( m ) sin ( 2 π {f}_{0} t ) + \\ {J}_{1} ( m ) \{ sin 2 π ( {f}_{0} + {f}_{m} ) t - sin 2 π ( {f}_{0} - {f}_{m} ) t \} + \\ {J}_{2} ( m ) \{ sin 2 π ( {f}_{0} + 2 {f}_{m} ) t + sin 2 π ( {f}_{0} - 2 {f}_{m} ) t \} + \\ {J}_{3} ( m ) \{ sin 2 π ( {f}_{0} + 3 {f}_{m} ) t - sin 2 π ( {f}_{0} - 3 {f}_{m} ) t \} + \\ …\end{matrix} ] = {A}_{0} [ \begin{matrix}{J}_{0} ( m ) sin ( 2 π {f}_{0} t ) + {\sum }_{n = 1}^{∞} {J}_{n} ( m ) sin 2 π ( {f}_{0} + n {f}_{m} ) t + \\ {\sum }_{n = 1}^{∞} {( - 1 )}^{n} {J}_{n} ( m ) sin 2 π ( {f}_{0} - n {f}_{m} ) t\end{matrix} ] \qquad ( 1 )$$

Here, Jₙ(m) is a Bessel function (n=0, 1, 2, . . . ). Besides, m denotes a modulation degree, and is in proportion to the amplitude of the modulation signal.

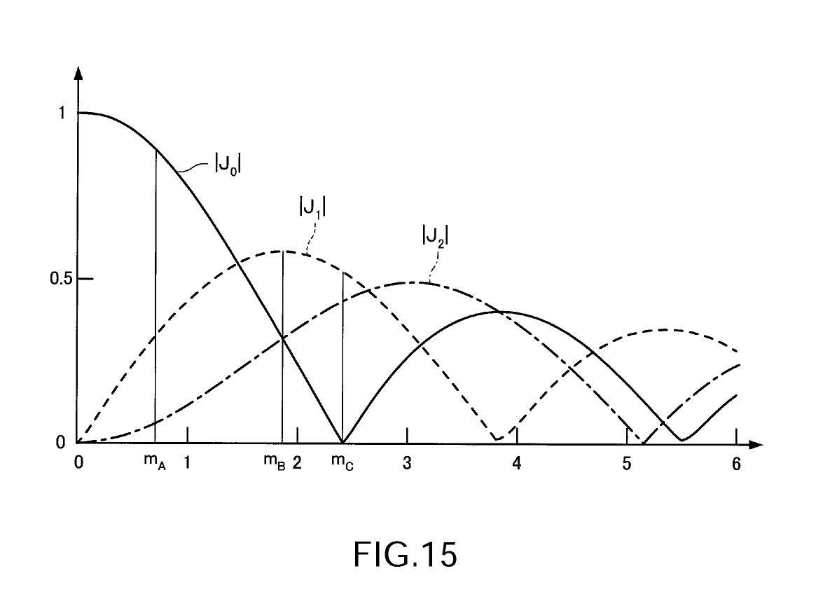

FIG. 15 is a schematic view of a graph showing Bessel functions J₀, J₁ and J₂. In FIG. 15, the horizontal axis indicates the modulation degree, and the vertical axis indicates the value (absolute value) of each of the Bessel functions. Besides, in FIG. 15, the respective Bessel functions J₀, J₁ and J₂ are expressed by a solid line, a broken line and a long and short dash line.

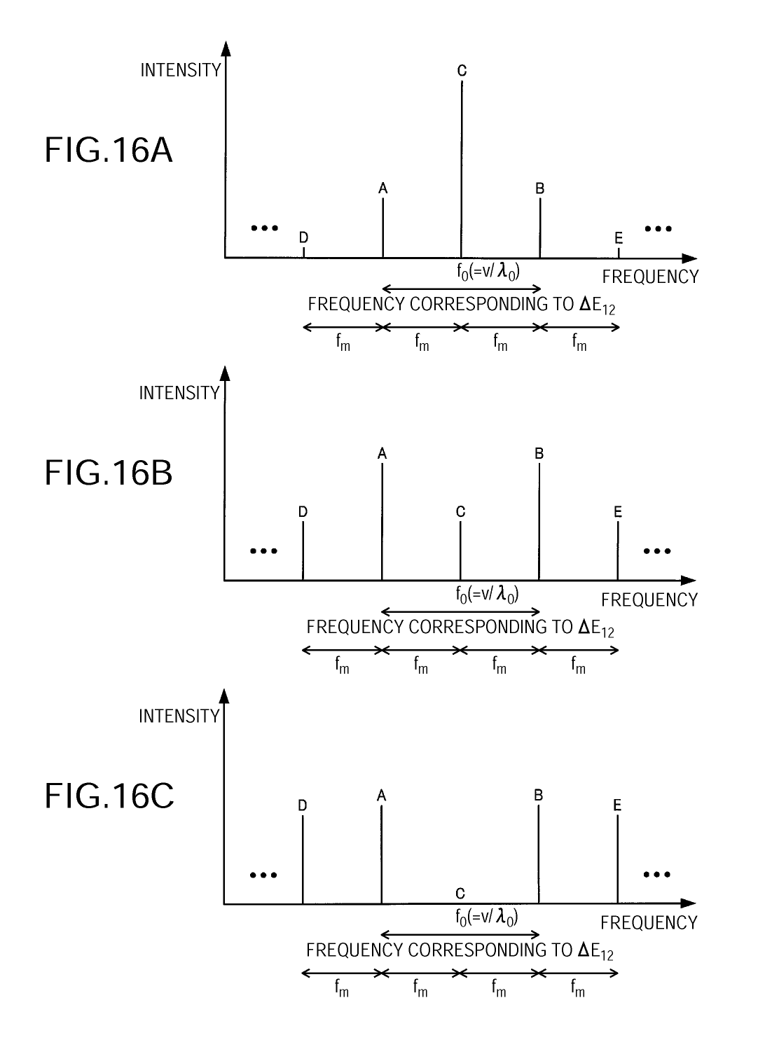

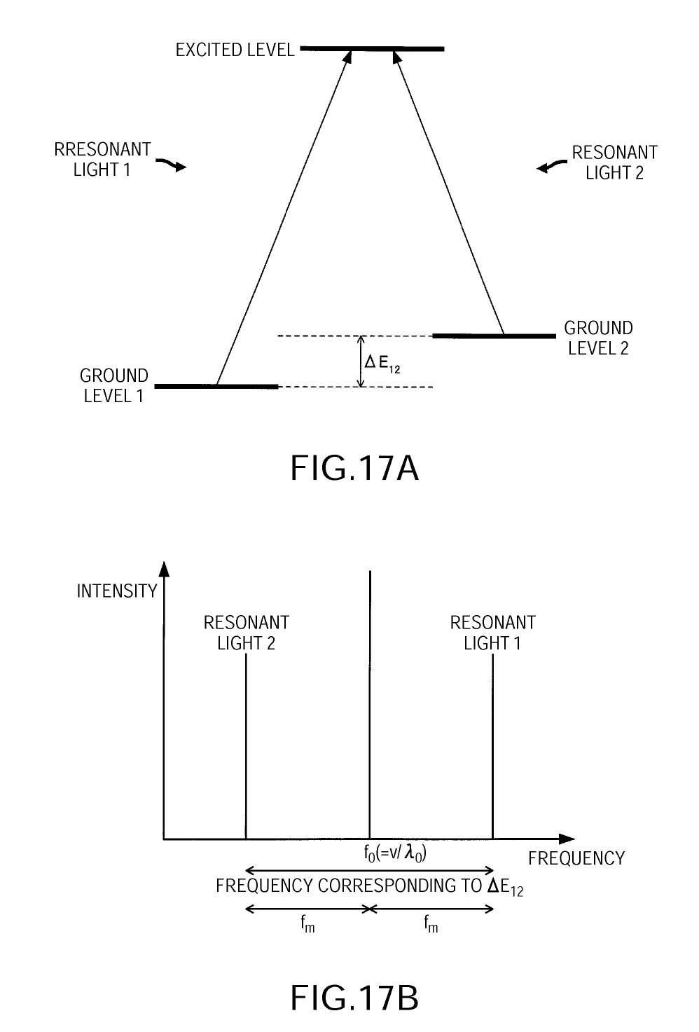

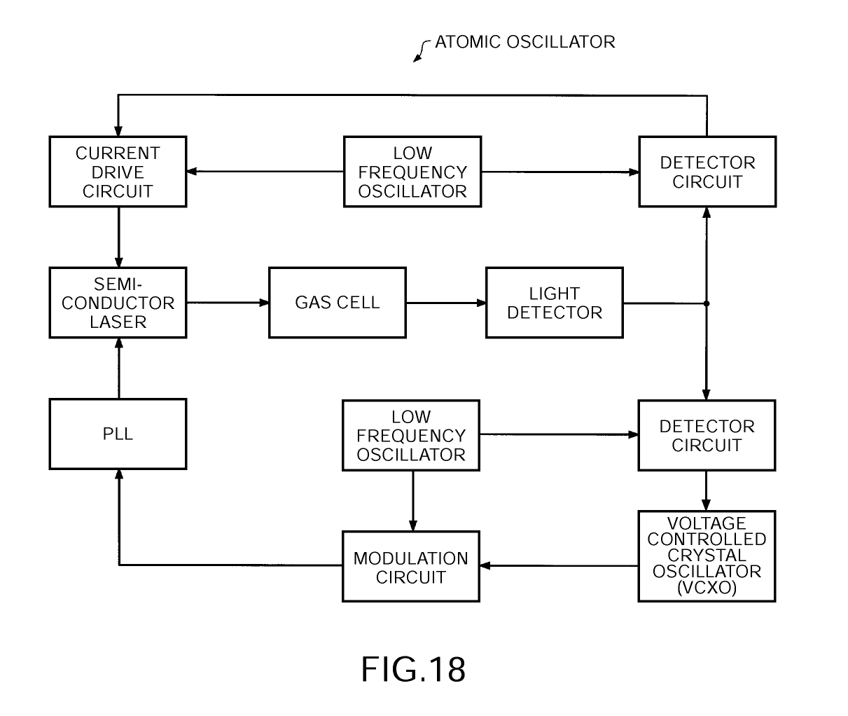

FIG. 16A, FIG. 16B and FIG. 16C show outlines of frequency spectra in the cases where the modulation degrees shown in FIG. 15 are m_{A}, m_{B} and m_{C}. In FIG. 16A, FIG. 16B and FIG. 16C, the intensity of the light C (frequency f₀) is in proportion to the absolute value (|J₀|) of J₀, and the intensity of each of the light A (frequency f₀−fₘ) and the light B (frequency f₀+fₘ) is in proportion to the absolute value (|J₁|) of J₁, and the intensity of each of the light D (frequency f₀−2fₘ) and the light E (frequency f₀+2fₘ) is in proportion to the absolute value (|J₂|) of J₂.

When the modulation degree is m_{A}, since |J₀|>|J₁|>|J₂| is established, as shown in FIG. 16A, the intensity of the light C>the intensity of the light A=the intensity of the light B>the intensity of the light D=the intensity of the light E is established. Besides, when the modulation degree is m_{B}, since |J₁|>|J₀|=|J₂| is established, as shown in FIG. 16B, the intensity of the light A=the intensity of the light B>the intensity of the light C=the intensity of the light D=the intensity of the light E is established. Besides, when the modulation degree is m_{C}, since |J₁|>|J₂|>|J₀|=0, as shown in FIG. 16C, the intensity of the light A=the intensity of the light B>the intensity of the light D=the intensity of the light E>the intensity of the light C=0 is established.

As described above, by adjusting the modulation degree m, the frequency spectrum of the outgoing light of the semiconductor laser 110 can be freely changed in accordance with the Bessel function. Since the modulation degree m is in proportion to the amplitude of the modulation signal, the semiconductor laser 110 can be made to generate the light having a desired frequency spectrum by adjusting the amplitude of the modulation signal to a specified magnitude by the level adjustment circuit 210.

For example, when the amplitude of the modulation signal is adjusted so that the modulation degree becomes m_{C} from m_{B}, as in the frequency spectrum of FIG. 16B or FIG. 16C, the intensities of the light A and the light B are made maximum, and the intensity of the light C can be made low. Accordingly, the band-pass filter 140 can be realized by a simpler filter, and according to circumstances, the band-pass filter 140 may not be provided.

The level adjustment circuit 210 can be constructed to attain a fixed gain by resistive potential division, or can be constructed such that the gain is adjusted to be variable by using an AGC (Auto Gain Control) circuit.

Incidentally, the semiconductor laser 110 and the light detector 130 correspond to the light source 10 and the light detection part 30 of FIG. 1. Besides, a circuit including the band-pass filter 140, the amplification circuit 150, the frequency conversion circuit 160, the level adjustment circuit 210, and the current drive circuit 170 corresponds to the frequency control part 40 of FIG. 1. Besides, the band-pass filter 140, the amplification circuit 150, and the frequency conversion circuit 160 correspond to the filer 42, the signal amplification part 44 and the frequency conversion part 46.

Also in the atomic oscillator 100E having the structure as described above, based on the same principle as the atomic oscillator 100A, the feedback control is performed so that the frequency difference of 2×fₘ between the light B and the light A coincides with the frequency corresponding to ΔE₁₂, that is, the light A and the light B become a resonant light pair. The feedback control can be realized by the circuit having the very simple structure as shown in FIG. 14 as compared with the related art structure. Accordingly, according to the fourth embodiment, the atomic oscillator in which reduction in size of a circuit portion and reduction in power consumption can be easily achieved can be realized.

Incidentally, the invention is not limited to the embodiments, and can be variously modified within the scope of the gist of the invention.

The invention includes substantially the same structure as the structure described in the embodiments (for example, the same structure in function, method and result, or the same structure in object and effect). Besides, the invention includes a structure in which an unessential portion is replaced in the structure described in the embodiment. Besides, the invention includes a structure having the same operation and effect as the structure described in the embodiment, or a structure in which the same object can be achieved. Besides, the invention includes a structure in which a well-known technique is added to the structure described in the embodiments.

The entire disclosure of Japanese Patent Application No. 2010-020946, filed Feb. 2, 2010 is expressly incorporated by reference herein.

What is claimed is:

1. An atomic oscillator using an electromagnetically induced transparency phenomenon caused by irradiating a resonant light pair to an alkali metal atom, comprising:
a gaseous alkali metal atom;
a light source that generates a plurality of lights having coherency and including a first light and a second light different from each other in frequency, and irradiates them to the alkali metal atom;
a light detection part that receives a plurality of lights passing through the alkali metal atom and generates a detection signal including a beat signal of a specified frequency obtained by interference of the plurality of lights; and
a frequency control part that performs frequency control of at least one of the first light and the second light based on the beat signal of the specified frequency included in the detection signal, and causes the first light and the second light to become a resonant light pair by which the electromagnetically induced transparency phenomenon is caused in the alkali metal atom.

2. The atomic oscillator according to claim 1, wherein the frequency control part includes a filter to select the beat signal of the specified frequency from the detection signal and to allow it to pass through, and performs the frequency control based on the beat signal selected by the filter.

3. The atomic oscillator according to claim 1, wherein the frequency control part includes a signal amplification part to amplify the detection signal or the beat signal selected by a filter, and performs the frequency control based on the signal amplified by the signal amplification part.

4. The atomic oscillator according to claim 1, further comprising an optical filter to select two lights to generate the beat signal of the specified frequency from the plurality of lights passing through the alkali metal atom and to allow them to pass through.

5. The atomic oscillator according to claim 1, wherein the frequency control part includes a frequency conversion part to convert the beat signal of the specified frequency into a signal of a different frequency, and performs the frequency control based on the signal converted by the frequency conversion part.

6. The atomic oscillator according to claim 1, wherein the frequency control part uses a beat signal of a frequency of ½ of a frequency difference between the first light and the second light as the beat signal of the specified frequency and performs the frequency control.

7. The atomic oscillator according to claim 1, wherein the frequency control part uses a beat signal of a frequency equal to a frequency difference between the first light and the second light as the beat signal of the specified frequency and performs the frequency control.
